(19) United States
(12) Patent Application Publication
(10) Pub. No.: US 2006/0118997 A1
(43) Pub. Date: Jun. 8, 2006

(54) Method for the production of a multimatrix of rubber and the use thereof for the simultaneous manufacture of a plurality of identical ornaments

(76) Inventors: Maurizio Gastaldi, Baldissero Torinese (IT); Alberto Menozzi, Torino (IT); Ivo Tozzi, Alpignano (IT)

Correspondence Address: SUGHRUE MION, PLLC, 2100 PENNSYLVANIA AVENUE, N.W., SUITE 800, WASHINGTON, DC, 20037, US

(21) Appl. No.: 10/552,352

(22) PCT Filed: Apr. 9, 2003
(86) PCT No.: PCT/IT03/00220

§ 371 Date: Oct. 7, 2005

(51) Int. Cl. B29C 33/40

(52) U.S. Cl. 264/225; 156/242

(57) ABSTRACT

The method comprises the stages of: preparing a metal matrix (12) which reproduces in positive form the shape of at least one ornament (10), forming a first hollow vessel, the bottom of which is constituted by the metal matrix (12), pouring a rubber (16) in the fluid state into the first vessel and leaving it to harden to give a matrix (18) of hardened rubber which reproduces in negative form the shape of at least one ornament (10), this operation being repeated several times, putting together the matrices (18) of hardened rubber in a side-by-side arrangement to give a composite structure (20), forming a second hollow vessel, the bottom of which is constituted by the composite structure (20), pouring a resin (24) into the second vessel and leaving it to harden to give an intermediate multimatrix (26), forming a third hollow vessel, the bottom of which is constituted by the intermediate multimatrix (26), and pouring a rubber (30) in the fluid state into the third vessel and leaving it to harden to give a rubber multimatrix (32) having several identical figures (34) into which is then poured a decorative resin (36) which forms the individual ornaments (10).

The present invention relates to the production of decorative elements of resin, in particular ornaments that can be fitted to various articles, such as the body of motor vehicles, electrical household appliances, bicycles, boats and the like. Typical examples of these ornaments are the plates which identify the type of model and which are fitted to the rear of a motor vehicle.

The object of the present invention is to permit the production of these ornaments, without restriction in terms of shape and at a limited cost, in amounts and at rates compatible with both large-scale and small-scale production, such as those of the articles to which they are to be fitted.

According to the invention, this object is achieved thanks to the methods having the features claimed specifically in the claims which follow.

Advantages and features of the present invention will emerge from the following detailed description which is provided by way of non-limiting example with reference to the appended drawings, in which:

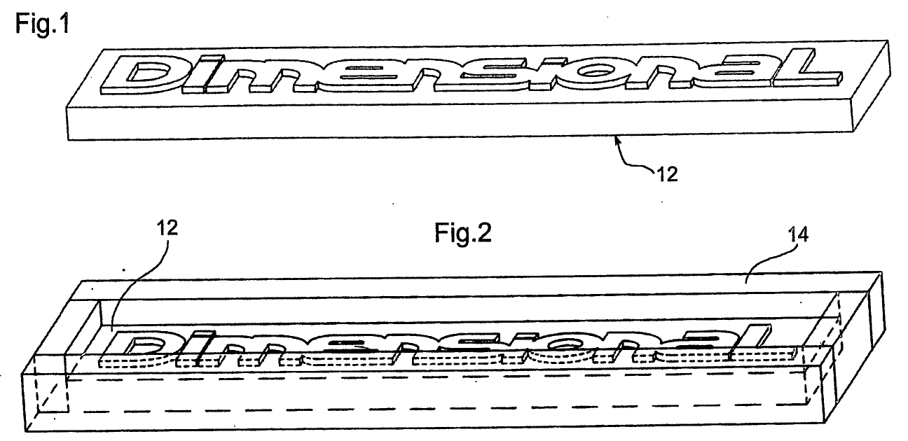

FIGS. 1 to 10 illustrate diagrammatically successive stages of a method for the production of a multimatrix of rubber,

FIG. 11 illustrates a stage in a method for the production of ornaments which provides for the use of this rubber multimatrix, and

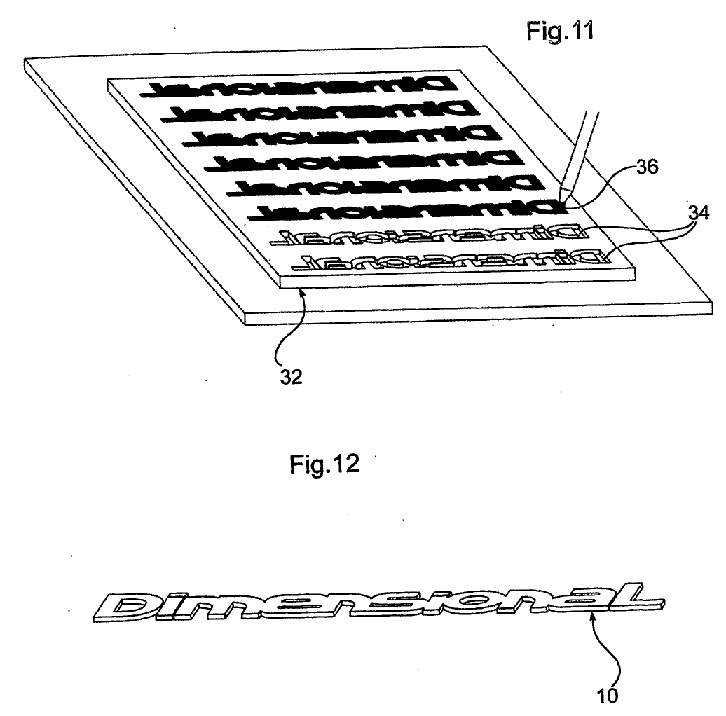

FIG. 12 illustrates an ornament produced using the method of the invention.

A method for the production of a rubber multimatrix which can be used for the simultaneous manufacture of a plurality of identical decorative elements of resin, in particular ornaments 10 (one of which is illustrated in FIG. 12), provides as the first stage (FIG. 1) the preparation of a metal matrix 12, for example of steel, which reproduces in positive form the shape of a single ornament 10 and has the desired surface finish (for example clear, opaque or glazed). In alternative embodiments of the invention not illustrated in the drawings, the matrix 12 may reproduce in positive form the shape of several ornaments 10.

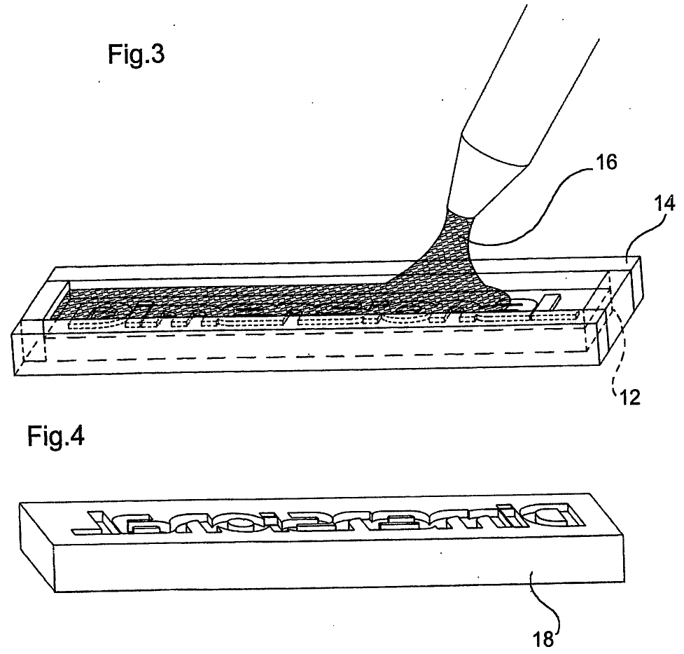

Subsequently, the metal matrix 12 is provided with lateral walls 14 in such a manner as to form a first hollow vessel, the bottom of which is constituted by the metal matrix 12 (FIG. 2) and into which a rubber (16) in the fluid state is poured (FIG. 3) so that it penetrates into all of the recesses.

Preferably, the rubber 16 has anti-adhesive properties and is free from additives, such as oils or plasticisers, capable of migrating.

The rubber 16 is then left to harden and is removed from the first vessel to give a hardened rubber matrix 18 (FIG. 4) which reproduces in negative form the shape of a single ornament 10. It will be appreciated that the matrix 18 will reproduce the shape of several ornaments 10 if a multi-figure metal matrix 12 has been used. The hardening may take place at ambient temperature or, preferably, at elevated temperature, for example in a furnace, in order to reduce the time necessary for its completion.

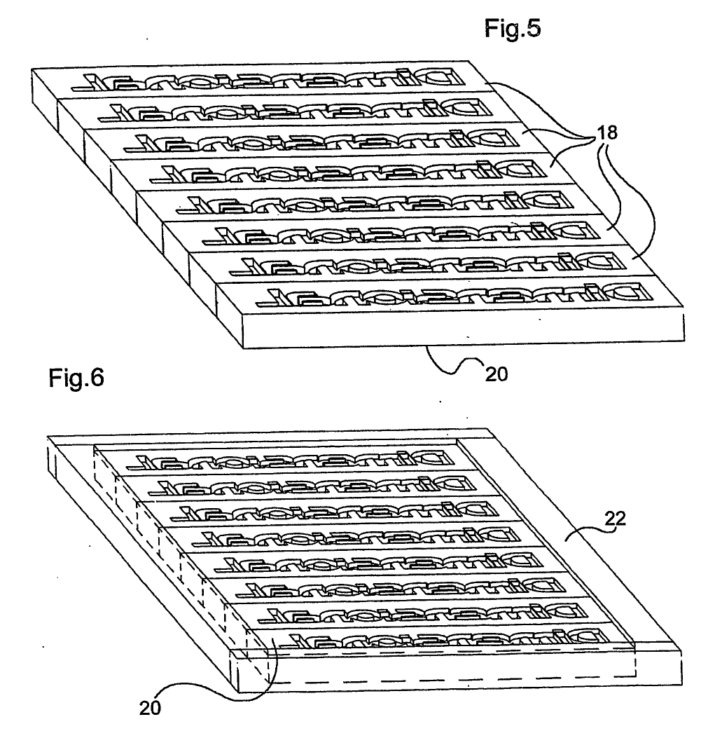

This operation is repeated several times until a plurality of identical rubber matrices 18 has been produced which are put together in a side-by-side arrangement (FIG. 5) to give a composite rubber structure 20 having several identical figures.

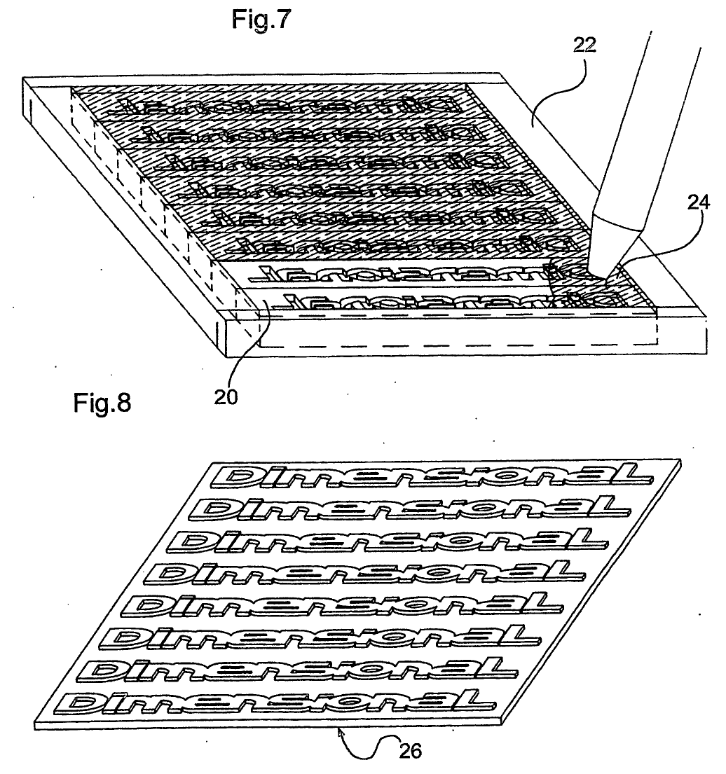

This latter structure is then provided with lateral walls 22 in such a manner as to form a second hollow vessel, the bottom of which is constituted by the composite structure 20 (FIG. 6) and into which a resin 24 (FIG. 7) of the type conventionally used to produce moulds is poured. The resin 24, for example of the polyurethane type, has a high degree of fluidity, a low degree of shrinkage and ensures good dimensional stability at elevated temperature.

The resin 24 is then left to harden and is removed from the second vessel to give (FIG. 8) an intermediate resin multimatrix 26 which reproduces in positive form the shape of a plurality of ornaments 10. In this case too, the hardening may take place at ambient temperature or at elevated temperature, for example at a temperature of from 45 to 50° C. for a period of time of from 10 to 12 hours.

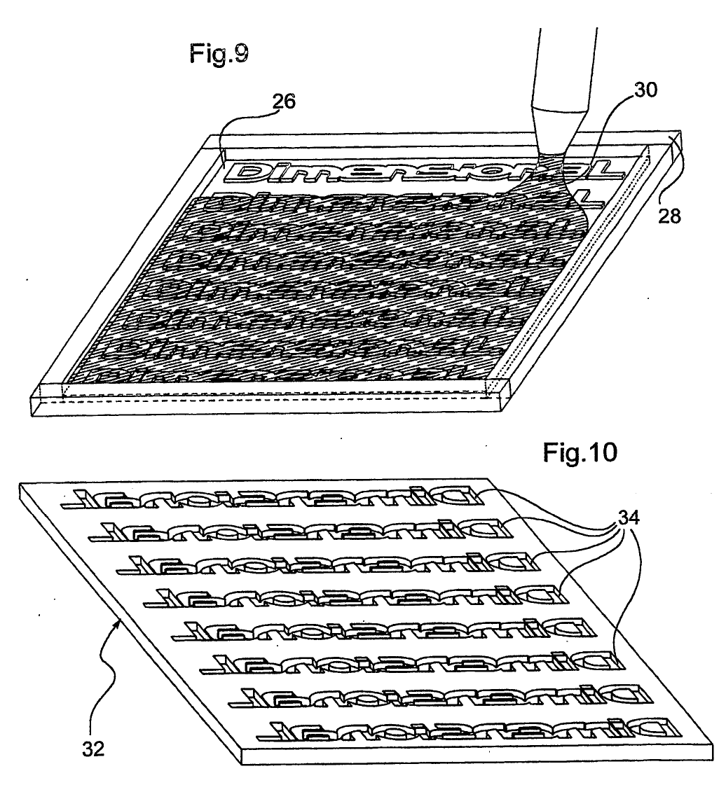

The intermediate multimatrix 26 is then provided with lateral walls 28 (FIG. 9) in such a manner as to form a third hollow vessel, the bottom of which is constituted by the multimatrix 26 and into which a rubber 30 in the fluid state is poured in a manner analogous to that described with reference to FIG. 3. The rubber 30 is then left to harden and is removed from the third vessel, in this case to give (FIG. 10) a rubber multimatrix 32 having several identical FIG. 34, each of which reproduces in negative form the shape of a single ornament 10.

The entire series of operations just described may be repeated several times until a desired number of multimatrices 32 is obtained. These multimatrices 32 are subsequently used in a method for the simultaneous manufacture of a plurality of identical ornaments 10.

In its broad outlines, this method provides that a decorative resin 36 is poured (FIG. 11) into each FIG. 34 of the multimatrix 32 and left to harden and finally the hardened decorative resin 36 is demoulded from each FIG. 34 to give a plurality of identical ornaments 10 (FIG. 12).

The resin 36, which is defined as “decorative”, is of the type conventionally used in this field and confers on the ornament 10 the desired properties of colour and/or of transparency, and also of hardness and resistance to environmental agents, such as ultraviolet radiation, humidity, temperature, salinity and the like. If desired, it is also possible to produce layered ornaments formed by several layers of decorative resins with various pouring operations carried out at successive times.

The hardening may take place at ambient temperature or at elevated temperature, for example in a tunnel-type furnace through which the multimatrices 32 in whose FIGS. 34 the decorative resin 36 has been poured, are caused to pass.

The method for the production of the ornaments 10 may also provide that, before the decorative resin 36 is poured, the surface of the FIGS. 34 is covered with a coating capable of subsequently adhering to the resin 36. This brings about the formation on the surface of the ornaments 10 of a covering whose aesthetic properties are determined by the type of coating used.

In addition, once the hardening of the resin 36 has been completed, it is possible to apply to the back of the ornaments 10 a bi-adhesive sheet which facilitates their removal from the mould and enables them subsequently to be fitted on the surface of an article to be decorated.

Advantageously, the various operations of the method for the production of the ornaments 10 may be carried out in work stations arranged along a carousel for handling the multimatrices 32. On the basis of the features of the stations and of the carousel, it is possible to select in the most advantageous manner the number of rubber multimatrices 32 to be used and the number of FIGS. 34 present in each of these multimatrices.

The method just described is not subject to particular limitations in connection with the shape and the dimensions of the profile of the surface of the ornaments 10. In particular, it is possible to obtain profiles having one or more sharp edges and/or one or more rounded portions of any type, with heights which may even be of the order of 8 mm.

The method for the production of the rubber multimatrices 32 permits optimum exploitation of the materials used, ensuring an optimum result from the point of view both of the final quality and of the economy of cost. A single matrix 12 of noble metal material is indeed used as the starting point for the subsequent operations which, however, provide for the use of more economical materials, such as resin 24 and rubber 16, 30. In particular, the metal matrix 12 enables a very restricted dimensional tolerance to be obtained, which is maintained in the intermediate multimatrix 26 and the final multimatrix 32, while hardly affecting the overall costs of the method. The implementation of this method is also very rapid, so that it is particularly advantageous when it is necessary to produce many different batches of identical ornaments 10 in rapid succession.

Naturally, the principle of the invention remaining the same, the details of construction and the forms of embodiment may be varied widely with respect to those described purely by way of example, without thereby departing from the scope of the invention.

What is claimed is:

1. A method for the production of a multimatrix (32) of rubber which can be used for the simultaneous manufacture of a plurality of identical decorative elements of resin, in particular ornaments (10), comprising the stages of:
preparing a metal matrix (12) which reproduces in positive form the shape of at least one ornament (10),
providing the metal matrix (12) with lateral walls (14) in such a manner as to form a first hollow vessel, the bottom of which is constituted by the metal matrix (12),
pouring into the first vessel a rubber (16) in the fluid state and leaving it to harden to give a hardened rubber matrix (18) which reproduces in negative form the shape of the at least one ornament (10), this operation being repeated until a plurality of matrices (18) of hardened rubber is obtained,
putting together the matrices (18) of hardened rubber in a side-by-side arrangement to give a composite rubber structure (20) having several identical figures,
providing the composite structure (20) with lateral walls (22) in such a manner as to form a second hollow vessel, the bottom of which is constituted by the composite structure (20),
pouring a resin (24) into the second vessel and leaving it to harden to give an intermediate multimatrix (26) which reproduces in positive form the shape of a plurality of ornaments (10),
providing the intermediate multimatrix (26) with lateral walls (28) in such a manner as to form a third hollow vessel, the bottom of which is constituted by the intermediate multimatrix (26), and
pouring into the third vessel a rubber (30) in the fluid state and leaving it to harden to give a rubber multimatrix (32) having several identical figures (34), each of which reproduces in negative form the shape of a single ornament (10).

2. A method according to claim 1, wherein the metal matrix (12) reproduces in positive form the shape of a single ornament (10).

3. A method according to claim 1, wherein said intermediate multimatrix (26) is hardened at a temperature of from 45 to 50° C. for a period of time of from 10 to 12 hours.

4. A method according to claim 1, wherein said rubber (16, 30) has anti-adhesive properties and is free from additives, such as oils or plasticisers, capable of migrating.

5. A method for the simultaneous manufacture of a plurality of identical decorative articles of resin, in particular ornaments (10), comprising the stages of:
preparing a multimatrix (32) of hardened rubber having several identical figures (34), each of which reproduces in negative form the shape of a single ornament (10),
pouring a resin (36) into each figure (34) and leaving it to harden, and
demoulding the hardened resin (36) from each figure to give a plurality of identical ornaments (10).

6. A method according to claim 5, which provides for covering the surface of the figures (34), before pouring the resin (36), with a coating capable of adhering to the decorative resin (36), in order to obtain a covering of the outer surface of the ornaments (10).

7. A method according to either claim 5, which provides that, when the resin (36) has hardened, a bi-adhesive sheet is applied to the back of the ornaments (10).
